(19) United States
(12) Patent Application Publication
(10) Pub. No.: US 2008/0227933 A1
(43) Pub. Date: Sep. 18, 2008

(54) Method For Producing Water-Absorbing Polymers

(75) Inventors: Rudiger Funk, Niedernhausen (DE); Matthias Weismantel, Jossgrund (DE); Uwe Stueven, Bad Soden (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF SE, Ludwigshafen (DE)

(21) Appl. No.: 11/997,943

(22) PCT Filed: Aug. 23, 2006
(86) PCT No.: PCT/EP2006/065588

§ 371 Date: Feb. 5, 2008

(30) Foreign Application Priority Data
Sep. 2, 2005 (DE) 10 2005 042 038.9

(51) Int. Cl. C08F 2/00

(52) U.S. Cl. 526/75

(57) ABSTRACT

The invention relates to a process for preparing water-absorbing polymers by polymerizing a monomer solution, wherein the oxygen content of the monomer solution has been reduced by addition of at least one reducing agent before the polymerization.

The present invention relates to a process for preparing water-absorbing polymers by polymerizing a monomer solution, wherein the oxygen content of the monomer solution has been reduced by addition of at least one reducing agent before the polymerization.

Further embodiments of the present invention can be taken from the claims, the description and the examples. It is evident that the features of the inventive subject-matter which have been mentioned above and are yet to be illustrated below can be used not only in the combination specified in each case but also in other combinations without leaving the scope of the invention.

Water-absorbing polymers are especially polymers of (co)polymerized hydrophilic monomers, graft (co)polymers of one or more hydrophilic monomers on a suitable graft base, crosslinked cellulose ethers or starch ethers, crosslinked carboxymethylcellulose, partly crosslinked polyalkylene oxide or natural products swellable in aqueous liquids, for example guar derivatives. Such polymers, as products which absorb aqueous solutions, are used to produce diapers, tampons, sanitary napkins and other hygiene articles, but also as water-retaining agents in market gardening.

The preparation of water-absorbing polymers is described, for example, in the monograph “Modern Superabsorbent Polymer Technology”, F. L. Buchholz and A. T. Graham, Wiley-VCH, 1998, or in Ullmann's Encyclopedia of Industrial Chemistry, 6th Edition, Volume 35, pages 73 to 103.

Water-absorbing polymers are typically prepared by free-radically polymerizing monomer solutions, for example based on partly neutralized acrylic acid. Oxygen inhibits free-radical polymerizations and is therefore usually removed substantially before the polymerization.

In known processes for physical oxygen removal, dissolved oxygen is displaced from the monomer solution by means of an inert gas. In so-called inertization, the inert gas is usually passed in countercurrent through the monomer solution. Good mixing and hence optimal inertization can be achieved, for example, by use of nozzles, static or dynamic mixers and bubble columns. The polymerization itself is frequently likewise carried out under inert gas. The inertization of the monomer solution with nitrogen is described, for example, in the monograph “Modern Superabsorbent Polymer Technology”, F. L. Buchholz and A. T. Graham, Wiley-VCH, 1998, or in Ullmann's Encyclopedia of Industrial Chemistry, 6th Edition, Volume 35, page 73.

DE-A-35 40 994 teaches the intimate mixing of the monomer solution and nitrogen in cocurrent in a Venturi nozzle and the removal thereby of the oxygen from the monomer solution. However, this procedure has the disadvantage that the nozzle is very easily blocked by polymer formation and the oxygen removal is thus liable to disruption. Furthermore, the inert gas consumption in this process is comparatively high.

DE-A-199 38 574 describes a continuous process for removing oxygen from monomer solutions with an inert gas in a column-shaped apparatus, the monomer solution and the inert gas flowing through the apparatus in countercurrent. The inert gas is introduced distributed in the form of fine bubbles at the bottom of the apparatus and drawn off at the top. The efficiency is increased by additional stirrer units.

All processes for inertizing the monomer solution which are known from the prior art require a comparatively high level of apparatus demand. In addition, an offgas line which continuously removes the gas mixture is also required. In addition to the high level of apparatus demands, the amount of inert gas required constitutes a cost factor. A disadvantage is also found to be that the apparatus is liable to faults, since premature polymerization occurs easily as a result of the removal of the oxygen.

WO-A-03/051415 describes inertization by thermal treatment, in which the monomer solution is heated to at least 40° C. In a preferred embodiment, the heat of neutralization is utilized to heat the monomer solution. Since the heated and inertized monomer solution polymerizes spontaneously, the components of the monomer solution have to be mixed in the polymerization reactor. A disadvantage here is the incomplete mixing on commencement of polymerization.

DE-A-199 55 861 discloses a continuous polymerization in which a monomer solution is inertized and admixed with the initiator solution in the polymerization reactor. In this polymerization, reducing agent and oxidizing agent of the redox initiator system used are metered in as separate solutions.

It was an object of the present invention to provide a process for preparing water-absorbing polymers, especially a simplified process for inertizing the monomer solution.

The object is achieved by processes for preparing water-absorbing polymers by polymerizing a monomer solution, wherein the oxygen content of the monomer solution has been reduced by addition of at least one reducing agent before the polymerization.

Before addition of the reducing agent, the oxygen content of the monomer solution is typically from 5 to 30 ppm by weight and, after addition of the reducing agent and before the polymerization, typically at most 4 ppm by weight, preferably at most 2 ppm by weight, more preferably at most 1 ppm by weight, most preferably at most 0.5 ppm by weight.

The reducing agents have to be able to react with the dissolved oxygen of the monomer solution under the given conditions and are subject to no further restriction. Suitable reducing agents are, for example, reducing agents which are also used as the reducing component in redox initiator systems, such as ascorbic acid, glucose, sorbose, the hydrogensulfite, sulfite, thiosulfate, hyposulfite, pyrosulfite or sulfide salts of ammonium or alkali metals, or sodium hydromethylsulfoxylate. Preference is given to using ascorbic acid or sodium pyrosulfite as the reducing agent.

For chemical removal of oxygen, the reducing agents are added to the monomer solution before the polymerization. Before the polymerization means, for example, before addition of the oxidizing component in the case of a redox polymerization, before the irradiation in the case of a photopolymerization and before the heating in the case of a thermal polymerization. When different initiator systems are used, before the polymerization means before the initiation of the first initiator system.

The amount of reducing agent which is used advantageously in the process according to the invention depends firstly upon the amount of dissolved oxygen and secondly upon the initiator system used.

When only the oxygen content of the monomer solution is to be lowered, typically at least 50 mol %, preferably at least 75 mol %, more preferably at least 90 mol %, and typically up to 150 mol %, preferably up to 125 mol %, most preferably up to 110 mol %, of reducing agent is used, based in each case on the dissolved oxygen.

The polymerization should not be initiated until the oxygen content of the monomer solution has fallen to the desired value. Typically, 20 minutes are sufficient for this purpose.

It will be appreciated that the process according to the invention is also suitable for supporting a typical physical oxygen removal. This can accelerate the oxygen removal and lower the inert gas requirement. The need for reducing agent and the reaction times can be adjusted downward if appropriate in this case according to the requirements.

In a preferred embodiment of the present invention, the polymerization is initiated by a redox initiator system. In this case, it is favorable to use the reducing agent used for oxygen removal in excess and simultaneously to use it as the reducing component in the redox polymerization.

Suitable oxidizing components of the preferred redox initiator systems are, for example, peroxides, hydroperoxides, hydrogen peroxide, persulfates.

Suitable organic peroxides are, for example, acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl per-2-ethylhexanoate, tert-butyl perisononanoate, tert-butyl permaleate, tert-butyl perbenzoate, di(2-ethylhexyl) peroxydicarbonate, dicyclohexyl peroxydicarbonate, di(4-tert-butylcyclohexyl) peroxydicarbonate, dimyristyl peroxydicarbonate, diacetyl peroxydicarbonate, allyl perester, cumyl peroxyneodecanoate, tert-butyl per-3,5,5-trimethylhexanoate, acetylcyclohexylsulfonyl peroxide, dilauryl peroxide, dibenzoyl peroxide and tert-amyl peroneodecanoate.

Among the oxidizing agents, preference is given to sodium peroxodisulfate and particular preference to the hydrogen peroxide/sodium peroxodisulfate combination.

Advantageously, the oxidizing agent is not added until within the polymerization reactor.

The polymerization reactors which can be used for the polymerization are subject to no restriction. The process according to the invention may be carried out batchwise or continuously. Continuous multishaft, preferably twin-shaft, kneaders with axially parallel flow are preferred.

The water-absorbing polymers are obtained, for example, by polymerization of a monomer solution comprising
a) at least one ethylenically unsaturated acid-functional monomer,
b) at least one crosslinker,
c) if appropriate one or more ethylenically and/or allylically unsaturated monomers copolymerizable with the monomer a), and
d) if appropriate one or more water-soluble polymers onto which the monomers a), b) and if appropriate c) can be at least partly grafted.

Suitable monomers a) are, for example, ethylenically unsaturated carboxylic acids, such as acrylic acid, methacrylic acid, maleic acid, fumaric acid and itaconic acid, or derivatives thereof, such as acrylamide, methacrylamide, acrylic esters and methacrylic esters. Particularly preferred monomers are acrylic acid and methacrylic acid. Very particular preference is given to acrylic acid.

The monomers a), especially acrylic acid, comprise preferably up to 0.025% by weight of a hydroquinone monoether. Preferred hydroquinone monoethers are hydroquinone monomethyl ether (MEHQ) and/or tocopherols.

Tocopherol refers to compounds of the following formula:

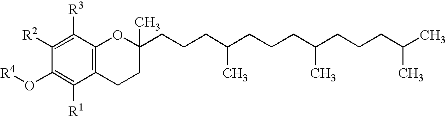

where R¹ is hydrogen or methyl, R² is hydrogen or methyl, R³ is hydrogen or methyl and R⁴ is hydrogen or an acyl radical having from 1 to 20 carbon atoms.

Preferred R⁴ radicals are acetyl, ascorbyl, succinyl, nicotinyl and other physiologically tolerable carboxylic acids. The carboxylic acids may be mono-, di- or tricarboxylic acids.

Preference is given to alpha-tocopherol where R¹═R²═R³=methyl, especially racemic alpha-tocopherol. R¹ is more preferably hydrogen or acetyl. Especially preferred is RRR-alpha-tocopherol.

The monomer solution comprises preferably not more than 130 ppm by weight, more preferably not more than 70 ppm by weight, preferably not less than 10 ppm by weight, more preferably not less than 30 ppm by weight and especially about 50 ppm by weight of hydroquinone monoether, based in each case on acrylic acid, with acrylic acid salts being counted as acrylic acid. For example, the monomer solution can be prepared using acrylic acid having an appropriate hydroquinone monoether content.

The crosslinkers b) are compounds having at least two polymerizable groups which can be free-radically polymerized into the polymer network. Suitable crosslinkers b) are, for example, ethylene glycol dimethacrylate, diethylene glycol diacrylate, allyl methacrylate, trimethylolpropane triacrylate, triallylamine, tetraallyloxyethane, as described in EP-A 0 530 438, di- and triacrylates, as described in EP-A 0 547 847, EP-A 0 559 476, EP-A 0 632 068, WO-A-93/21237, WO-A-03/104299, WO-A-03/104300, WO-A-03/104301 and DE-A 103 31 450, mixed acrylates which, as well as acrylate groups, comprise further ethylenically unsaturated groups, as described in DE-A 103 31 456 and WO-A-04/013064, or crosslinker mixtures as described, for example, in DE-A 195 43 368, DE-A 196 46 484, WO-A-90/15830 and WO-A-02/32962.

Suitable crosslinkers b) include in particular N,N′-methylenebisacrylamide and N,N′-methylenebismethacrylamide, esters of unsaturated mono- or polycarboxylic acids of polyols, such as diacrylate or triacrylate, for example butanediol diacrylate, butanediol dimethacrylate, ethylene glycol diacrylate, ethylene glycol dimethacrylate and also trimethylolpropane triacrylate and allyl compounds, such as allyl (meth)acrylate, triallyl cyanurate, diallyl maleate, polyallyl esters, tetraallyloxyethane, triallylamine, tetraallylethylenediamine, allyl esters of phosphoric acid and also vinylphosphonic acid derivatives as described, for example, in EP-A 0 343 427. Suitable crosslinkers b) further include pentaerythritol diallyl ether, pentaerythritol triallyl ether, pentaerythritol tetraallyl ether, polyethylene glycol diallyl ether, ethylene glycol diallyl ether, glycerol diallyl ether, glycerol triallyl ether, polyallyl ethers based on sorbitol, and also ethoxylated variants thereof. In the process of the invention, it is possible to use di(meth)acrylates of polyethylene glycols, the polyethylene glycol used having a molecular weight between 300 and 1000.

However, particularly advantageous crosslinkers b) are di- and triacrylates of 3- to 15-tuply ethoxylated glycerol, of 3- to 15-tuply ethoxylated trimethylolpropane, of 3- to 15-tuply ethoxylated trimethylolethane, especially di- and triacrylates of 2- to 6-tuply ethoxylated glycerol or of 2- to 6-tuply ethoxylated trimethylolpropane, of 3-tuply propoxylated glycerol, of 3-tuply propoxylated trimethylolpropane, and also of 3-tuply mixed ethoxylated or propoxylated glycerol, of 3-tuply mixed ethoxylated or propoxylated trimethylolpropane, of 15-tuply ethoxylated glycerol, of 15-tuply ethoxylated trimethylolpropane, of 40-tuply ethoxylated glycerol, of 40-tuply ethoxylated trimethylolethane and also of 40-tuply ethoxylated trimethylolpropane.

Very particularly preferred crosslinkers b) are polyethoxylated and/or -propoxylated glycerols which have been esterified with acrylic acid or methacrylic acid to di- or triacrylates, as described, for example, in WO-A-03/104301. Di- and/or triacrylates of 3- to 10-tuply ethoxylated glycerol are particularly advantageous. Very particular preference is given to di- or triacrylates of 1- to 5-tuply ethoxylated and/or propoxylated glycerol. The triacrylates of 3- to 5-tuply ethoxylated and/or propoxylated glycerol are most preferred. These are notable for particularly low residual levels (typically below 10 ppm by weight) in the water-absorbing polymer and the aqueous extracts of the water-absorbing polymers produced therewith have an almost unchanged surface tension (typically not less than 0.068 N/m) compared with water at the same temperature.

The amount of crosslinker b) is preferably from 0.01 to 1% by weight, more preferably from 0.05 to 0.5% by weight, most preferably from 0.1 to 0.3% by weight, based in each case on the monomer a).

Examples of ethylenically unsaturated monomers c) which are copolymerizable with the monomers a) are acrylamide, methacrylamide, crotonamide, dimethylaminoethyl methacrylate, dimethylaminoethyl acrylate, dimethylaminopropyl acrylate, diethylaminopropyl acrylate, dimethylaminobutyl acrylate, dimethylaminoethyl methacrylate, diethylaminoethyl methacrylate, dimethylaminoneopentyl acrylate and dimethylaminoneopentyl methacrylate.

Useful water-soluble polymers d) include polyvinyl alcohol, polyvinylpyrrolidone, starch, starch derivatives, polyglycols or polyacrylic acids, preferably polyvinyl alcohol and starch.

The preparation of a suitable base polymer and also further suitable hydrophilic ethylenically unsaturated monomers d) are described in DE-A 199 41 423, EP-A 0 686 650, WO-A-01/45758 and WO-A-03/104300.

Water-absorbing polymers are typically obtained by addition polymerization of an aqueous monomer solution and, if appropriate, subsequent comminution of the hydrogel. Suitable preparation methods are described in the literature. Water-absorbing polymers are obtainable, for example, by
gel polymerization in the batch process or tubular reactor and subsequent comminution in meat grinder, extruder or kneader (EP-A-0 445 619, DE-A-19 846 41 3)
addition polymerization in kneader with continuous comminution by contrarotatory stirring shafts for example (WO-A-01/38402)
addition polymerization on belt and subsequent comminution in meat grinder, extruder or kneader (DE-A-38 25 366, U.S. Pat. No. 6,241,928)
emulsion polymerization, which produces bead polymers having a relatively narrow gel size distribution (EP-A-0 457 660)
in situ addition polymerization of a woven fabric layer which, usually in a continuous operation, has previously been sprayed with aqueous monomer solution and subsequently been subjected to a photopolymerization (WO-A-02/94328, WO-A-02/94329).

The reaction is preferably carried out in a kneader, as described, for example, in WO-A-01/38402, or on a belt reactor, as described, for example, in EP-A 0 955 086.

The acid groups of the resulting hydrogels have typically been partially neutralized, preferably to an extent of from 25 to 85 mol %, more preferably to an extent of from 27 to 80 mol % and even more preferably to an extent of from 27 to 30 mol % or 40 to 75 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metals are sodium and potassium, but very particular preference is given to sodium hydroxide, sodium carbonate or sodium hydrogencarbonate and also mixtures thereof. Neutralization is typically achieved by mixing in the neutralizing agent as an aqueous solution or else preferably as a solid material. For example, sodium hydroxide having a water content of distinctly below 50% by weight can be present as a waxy mass having a melting point of above 23° C. In this case, metering as piece material or melt at elevated temperature is possible.

Neutralization can be carried out after the polymerization, at the hydrogel stage. It is also possible to neutralize up to 40 mol %, preferably from 10 to 30 mol % and more preferably from 15 to 25 mol % of the acid groups before the polymerization by adding a portion of the neutralizing agent to the monomer solution and setting the desired final degree of neutralization only after the polymerization, at the hydrogel stage. The monomer solution can be neutralized by mixing in the neutralizing agent. The hydrogel may be comminuted mechanically, for example by means of a meat grinder, in which case the neutralizing agent can be sprayed, sprinkled or poured on and then carefully mixed in. To this end, the gel mass obtained can be repeatedly ground in the meat grinder for homogenization. Neutralization of the monomer solution to the final degree of neutralization is preferred.

The neutralized hydrogel is then dried with a belt or drum dryer until the residual moisture content is preferably below 15% by weight and especially below 10% by weight, the water content being determined by EDANA (European Disposables and Nonwovens Association) recommended test method No. 430.2-02 “Moisture content”. If desired, drying can also be carried out using a fluidized bed dryer or a heated plowshare mixer. To obtain particularly white products, it is advantageous to dry this gel while ensuring rapid removal of the evaporating water. To this end, the dryer temperature must be optimized, the air feed and removal has to be controlled, and sufficient venting must be ensured in each case. The higher the solids context of the gel, the simpler the drying, by its nature, and the whiter the product. The solids content of the gel before the drying is therefore preferably between 30% and 80% by weight. It is particularly advantageous to vent the dryer with nitrogen or another nonoxidizing inert gas. If desired, however, it is possible simply just to lower the partial pressure of the oxygen during the drying in order to prevent oxidative yellowing processes. In general, though, adequate venting and removal of the water vapor also still lead to an acceptable product. A very short drying time is generally advantageous with regard to color and product quality.

The dried hydrogel is preferably ground and sieved, useful grinding apparatus typically including roll mills, pin mills or swing mills. The particle size of the sieved, dry hydrogel is preferably below 1000 μm, more preferably below 900 μm and most preferably below 800 μm, and preferably above 100 μm, more preferably above 150 μm and most preferably above 200 μm.

Very particular preference is given to a particle size (sieve cut) of from 106 to 850 μm.

The particle size is determined according to EDANA (European Disposables and Nonwovens Association) recommended test method No. 420.2-02 “Particle size distribution”.

The base polymers are then preferably surface postcrosslinked. Postcrosslinkers suitable for this purpose are compounds comprising two or more groups capable of forming covalent bonds with the carboxylate groups of the hydrogel. Suitable compounds are, for example, alkoxysilyl compounds, polyaziridines, polyamines, polyamidoamines, di- or polyglycidyl compounds, as described in EP-A 0 083 022, EP-A 543 303 and EP-A 937 736, di- or polyfunctional alcohols, as described in DE-C 33 14 019, DE-C 35 23 617 and EP-A 0 450 922, or β-hydroxyalkylamides, as described in DE-A 102 04 938 and U.S. Pat. No. 6,239,230.

In addition, DE-A 40 20 780 describes cyclic carbonates, DE-A 198 07 502 2-oxazolidone and its derivatives, such as 2-hydroxyethyl-2-oxazolidone, DE-A 198 07 992 bis- and poly-2-oxazolidinones, DE-A 198 54 573 2-oxotetrahydro-1,3-oxazine and its derivatives, DE-A 198 54 574 N-acyl-2-oxazolidones, DE-A 102 04 937 cyclic ureas, DE-A 103 34 584 bicyclic amide acetals, EP-A 1 199 327 oxetanes and cyclic ureas and WO-A-03/031482 morpholine-2,3-dione and its derivatives, as suitable surface postcrosslinkers.

The postcrosslinking is typically carried out in such a way that a solution of the surface postcrosslinker is sprayed onto the hydrogel or onto the dry base polymer powder. After the spraying, the polymer powder is dried thermally, and the crosslinking reaction may take place either before or during drying.

The spraying with a solution of the crosslinker is preferably carried out in mixers having moving mixing implements, such as screw mixers, paddle mixers, disk mixers, plowshare mixers and shovel mixers. Particular preference is given to vertical mixers and very particular preference to plowshare mixers and shovel mixers. Suitable mixers are, for example, Lödige® mixers, Bepex® mixers, Nauta® mixers, Processall® mixers and Schugi® mixers.

The thermal drying is preferably carried out in contact dryers, more preferably shovel dryers and most preferably disk dryers. Suitable dryers are, for example, Bepex® dryers and Nara® dryers. It is also possible to use fluidized bed dryers.

The drying can be effected in the mixer itself, by heating the jacket or blowing in warm air. It is equally possible to use a downstream dryer, for example a tray dryer, a rotary tube oven or a heatable screw. It is also possible, for example, to utilize an azeotropic distillation as a drying process.

Preferred drying temperatures are in the range from 50 to 250° C., preferably in the range from 50 to 200° C. and more preferably in the range from 50 to 150° C. The preferred residence time at this temperature in the reaction mixer or dryer is below 30 minutes and more preferably below 10 minutes.

The present invention further provides for the use of the water-absorbing polymers prepared by the process according to the invention for producing hygiene articles, especially diapers.

The process according to the invention enables the simple inertization of monomer solutions before polymerization.

The water-absorbing polymers prepared by the process according to the invention have, compared to the customary physical oxygen removal, a lower residual monomer content and a more favorable ratio of Centrifuge Retention Capacity to Extractables.

Water-absorbing polymers are lightly crosslinked polymers. Undesired chain termination reactions during the polymerization increase the fraction of short and hence also uncrosslinked polymer chains (Extractables); the ratio of Centrifuge Retention Capacity to Extractables becomes smaller.

### Methods:

The measurements should be carried out, unless stated otherwise, at an ambient temperature of 23±2° C. and a relative humidity of 50±10%. The water-absorbing polymers are thoroughly mixed through before measurement.

### Residual Monomers

The level of residual monomers in the water-absorbing polymeric particles is determined by EDANA (European Disposables and Nonwovens Association) recommended test method No. 410.2-02 “Residual monomers”.

### Centrifuge Retention Capacity (CRC)

Centrifuge Retention Capacity of the water-absorbing polymeric particles is determined by EDANA (European Disposables and Nonwovens Association) recommended test method No. 441.2-02 “Centrifuge retention capacity”.

### Extractables

The content of extractable constituents in the water-absorbing polymeric particles is determined by EDANA (European Disposables and Nonwovens Association) recommended test method No. 470.2-02 “Extractables”.

The EDANA test methods are obtainable for example at European Disposables and Nonwovens Association, Avenue Eugène Plasky 157, B-1030 Brussels, Belgium.

### EXAMPLES

### Example 1

1 kg of a 33% by weight aqueous acrylic acid/sodium acrylate solution with a degree of neutralization of 71.5 mol % was admixed at 29° C. with 9 g of 0.5% by weight aqueous ascorbic acid solution. Subsequently, the decrease in the oxygen content of the monomer solution was measured.

TAB. 1
Oxygen content

| Reaction time [minutes] | Oxygen content [ppm by wt.] |
|---|---|
| 0 | 9.0 |
| 1 | 8.5 |
| 2 | 8.2 |
| 3 | 8.1 |
| 4 | 7.9 |
| 5 | 7.8 |
| 6 | 7.6 |
| 7 | 7.3 |
| 8 | 7.0 |
| 9 | 6.8 |
| 10 | 6.6 |
| 11 | 6.5 |
| 12 | 6.3 |
| 13 | 5.0 |
| 14 | 3.0 |
| 15 | 2.2 |
| 16 | 1.5 |
| 17 | 1.1 |
| 18 | 0.5 |

The results show that the monomer solution can be inertized by addition of ascorbic acid.

### Example 2

1 kg of a 33% by weight aqueous acrylic acid/sodium acrylate solution with a degree of neutralization of 71.5 mol % was admixed at 29° C. with 6 g of a 0.5% by weight aqueous ascorbic acid solution.

The monomer solution comprised 0.4% by weight, based on acrylic acid, of 15-tuply ethoxylated trimethylolpropane triacrylate as a crosslinker.

15 minutes after addition of the ascorbic acid solution, the polymerization was initiated by metering in a mixture of hydrogen peroxide and sodium peroxydisulfate.

Based on acrylic acid, 0.007% by weight of hydrogen peroxide (as 0.25% by weight aqueous solution) and 0.02% by weight of sodium peroxydisulfate (as a 15% by weight aqueous solution) were used. The initiator mixture was prepared by mixing the two aqueous solutions.

The resulting product gel was comminuted, dried in a forced-air drying cabinet at 170° C. for one hour, ground and sieved to from 150 to 850 μm.

Subsequently, residual monomer content, Centrifuge Retention Capacity and Extractables were determined. The results are compiled in table 2. They show that, with comparable other properties, water-absorbing polymers with a lower level of Extractables and a lower level of residual monomers can be obtained by the process according to the invention.

### Example 3

The procedure of example 2 was repeated. 7 g of a 0.5% by weight aqueous ascorbic acid solution were used. The reaction time for chemical oxygen removal was 14 minutes.

### Example 4

The procedure of example 2 was repeated. 8 g of a 0.5% by weight aqueous ascorbic acid solution were used. The reaction time for chemical oxygen removal was 15 minutes.

### Example 5

The procedure of example 2 was repeated. 9 g of a 0.5% by weight aqueous ascorbic acid solution were used. The reaction time for chemical oxygen removal was 17.5 minutes.

### Example 6

The procedure of example 2 was repeated. 9 g of a 0.5% by weight aqueous ascorbic acid solution were used. The reaction time for chemical oxygen removal was 18 minutes.

### Example 7

The procedure of example 2 was repeated. Instead of inertizing with an aqueous ascorbic acid solution, the monomer solution was inertized with nitrogen. To this end, nitrogen was passed through the monomer solution at a rate of 25 l/h for 3 minutes.

To initiate the polymerization, an additional 0.0015% by weight of ascorbic acid, based on acrylic acid, was added. Ascorbic acid was added as a 0.5% by weight aqueous solution.

### Example 8

The procedure of example 7 was repeated. The monomer solution was inertized with 50 l/h of nitrogen for 3 minutes.

### Example 9

The procedure of example 7 was repeated. The monomer solution was inertized with 10 l/h of nitrogen for 7 minutes.

### Example 10

The procedure of example 7 was repeated. The monomer solution was inertized with 100 l/h of nitrogen for 30 minutes.

TAB. 2
Results

| | | | | CRC/Ex- | Residual |
|---|---|---|---|---|---|
| | | CRC | Extractables | tractables | monomers |
| Ex. | Inertization | [g/g] | [% by wt.] | ratio | [ppm by wt.] |
| 2 | 30 mg Asc/15 | 43.0 | 11.9 | 3.60 | 3600 |
| | min | | | | |
| 3 | 35 mg Asc/14 | 44.9 | 11.0 | 4.08 | 3570 |
| | min | | | | |
| 4 | 40 mg Asc/15 | 44.4 | 12.0 | 3.70 | 3670 |
| | min | | | | |
| 5 | 45 mg Asc/17.5 | 44.0 | 10.5 | 4.20 | 3610 |
| | min | | | | |
| 6 | 45 mg Asc/18 | 43.7 | 11.1 | 3.94 | 3400 |
| | min | | | | |
| 7*) | 1.25 I N₂/3 min | 50.7 | 14.1 | 3.59 | 5120 |
| 8*) | 2.5 I N₂/3 min | 56.4 | 18.3 | 3.07 | 4070 |
| 9*) | 1.17 I N₂/7 min | 47.1 | 12.7 | 3.50 | 6310 |
| 10*) | 50 I N₂/30 min | 49.3 | 14.5 | 3.40 | 3850 |

*)Comparison
Asc: Ascorbic acid (chemical inertization)
N₂: Nitrogen (physical inertization)

The polymers prepared by the process according to the invention have a lower level of Extractables and a lower level of residual monomer.

1. A process for preparing surface postcrosslinked water-absorbing polymers by polymerizing a monomer solution, wherein an oxygen content of the monomer solution has been reduced by an addition of at least one reducing agent before the polymerization.

2. The process according to claim 1, wherein the oxygen content of the monomer solution, after the addition of the at least one reducing agent and before the polymerization, is below 1 ppm by weight.

3. The process according to claim 1, wherein the at least one reducing agent is ascorbic acid.

4. The process according to claim 1, wherein the amount of the at least one reducing agent is from 50 to 150 mol % based on the oxygen dissolved in the monomer solution.

5. The process according to claim 1, wherein the polymerization is a redox polymerization.

6. The process according to claim 5, wherein an oxidizing agent of the redox initiator system is not added until within a polymerization reactor.

7. The process according to claim 5, wherein sodium peroxodisulfate is used as an oxidizing agent.

8. The process according to claim 5, wherein hydrogen peroxide is used as an additional oxidizing agent.

9. The process according to claim 1, wherein the monomer solution is inertized before the polymerization exclusively by addition of at least one reducing agent.

10. (canceled)
